(19) United States
(12) Patent Application Publication
(10) Pub. No.: US 2024/0336487 A1
(43) Pub. Date: Oct. 10, 2024

(54) METHOD FOR MODELING GRAPHITE AND GRAPHITE MODELED OBJECT

(71) Applicant: CANON KABUSHIKI KAISHA, Tokyo (JP)

(72) Inventor: MOTOKI OKINAKA, Tokyo (JP)

(21) Appl. No.: 18/750,045

(22) Filed: Jun. 21, 2024

Related U.S. Application Data
(63) Continuation of application No. PCT/JP2022/046019, filed on Dec. 14, 2022.

(30) Foreign Application Priority Data
Dec. 22, 2021 (JP) 2021-208536

(51) Int. Cl. C01B 33/021; B33Y 10/00; B33Y 70/00; B33Y 80/00; C01B 32/05

(52) U.S. Cl. CPC C01B 33/021; B33Y 10/00; B33Y 70/00; B33Y 80/00; C01B 32/05

(57) ABSTRACT

A method for manufacturing an article containing graphite includes laying a powder and solidifying the powder by applying laser light to the powder, wherein the powder contains a graphite powder and a silicon carbide powder, and in the solidifying of the powder, the laser light is applied under a condition that the silicon carbide powder is decomposed into carbon and silicon.

### CROSS-REFERENCE TO RELATED APPLICATIONS

This application is a Continuation of International Patent Application No. PCT/JP2022/046019, filed Dec. 14, 2022, which claims the benefit of Japanese Patent Application No. 2021-208536, filed Dec. 22, 2021, both of which are hereby incorporated by reference herein in their entirety.

### TECHNICAL FIELD

The present invention relates to technology to produce an article containing graphite as a primary component by using a raw material powder containing graphite and using powder bed fusion.

### BACKGROUND ART

Since graphite has excellent characteristics, such as thermal resistance, heat dissipation, electrical conductivity, and chemical resistance, structures containing graphite have been used in various fields.

PTL 1 discloses a method in which a graphite mixture containing rhombohedral graphite and an additive and/or a binder, as the situation demands, is compression-molded and, thereafter, heat-treated in the absence of oxygen so as to obtain a molded body.

PTL 2 proposes a method for producing a graphite molded body in which a solvent is removed from a molded object of graphene oxide obtained by molding a solvent dispersion of graphene oxide and the resulting molded object is subjected to a reduction step by electrical heating and a pressurization step in combination.

### CITATION LIST

### Patent Literature

PTL 1: Japanese Patent Laid-Open No. 8-175870
PTL 2: Japanese Patent Laid-Open No. 2019-206447

The methods in which a molded body is formed by molding a raw material containing graphite, as described in PTL 1 and PTL 2, are in need of preparation of a mold for molding at first so that the time and the cost therefor are required and are unsuitable for production of prototypes and high-mix low-volume articles.

In recent years, the powder bed fusion which is one of the additive manufacturing technology (so-called 3D printing) has been used for production of articles. The powder bed fusion is a method in which laser is applied to a raw material powder of metal, resin, or the like in accordance with the shape data of an article to be produced so as to perform melting and modeling. Using the powder bed fusion enables a modeled object to be obtained with a high degree of modeling flexibility in a relatively short time and, therefore, is suitable for production of, in particular, prototypes having a complex shape and high-mix low-volume articles.

However, graphite has a very high melting point of 3,700° C. to 4,000° C. in contrast to metal, resin, and the like, and it is difficult that a graphite powder is melted and modeled by application of laser.

### SUMMARY OF INVENTION

The present invention provides a method for manufacturing an article containing graphite, the method including laying a powder and solidifying the powder by applying laser light to the powder, wherein the powder contains a graphite powder and a silicon carbide powder, and in the solidifying of the powder, the laser is applied under a condition that the silicon carbide powder is decomposed into carbon and silicon.

Further features of the present invention will become apparent from the following description of exemplary embodiments with reference to the attached drawings.

### BRIEF DESCRIPTION OF DRAWINGS

FIG. 1 is a schematic diagram of an apparatus according to the present invention.

FIG. 2A is a schematic diagram illustrating the order of laser irradiation in the present invention.

FIG. 2B is a schematic diagram illustrating the order of laser irradiation in the related art.

FIG. 3A is a diagram illustrating the focus position of laser light.

FIG. 3B is a diagram illustrating the light intensity distribution at a focus position and a defocus position of laser light.

FIG. 4 is a diagram illustrating a manner in which modeling is performed by applying laser light in a defocus state.

### DESCRIPTION OF EMBODIMENTS

The powder bed fusion is a method in which a raw material powder is laid and leveled having a predetermined thickness, and the powder is repeatedly melted and solidified in the order of milliseconds by laser light scanning in accordance with slice data produced from shape data of a model to be modeled so that modeling is performed.

Since graphite has a very high melting point of 3,700° C. to 4,000° C., it is difficult to melt and model a graphite powder in the order of milliseconds by laser light scanning. In this regard, when a resin is mixed into a graphite powder and modeling is performed using, as a binder, the resin melted by laser light, organic materials have to be removed (degreased) at the end, and a modeled object shrinks due to degreasing. To obtain the modeled object with high precision, an operator is required to have high degree of skill.

As a result of intensive investigation to address such problems, a method in which a silicon carbide powder that functions as a binder is added to a graphite powder so as to produce an article containing graphite was found. An embodiment for realizing the present invention will be described below in detail.

Silicon carbide is a material having higher resistivity than graphite, having thermal resistance, thermal conductivity, linear expansion coefficient, and the like equivalent to those of graphite, and having more excellent mechanical strength than graphite. The physical properties of an article obtained by the present invention deviate from the physical properties of simple graphite in accordance with a mixing ratio of a graphite powder and a silicon carbide powder. However, necessary physical properties can be satisfied by adjusting the mixing ratio in accordance with an application.

Silicon carbide is a sublimable substance that vaporizes at 3,500° C. and is decomposed into carbon and silicon in a temperature range of 2,800° C. or higher and lower than 3,500° C., and at least a portion of silicon due to thermal decomposition is present in a state of a molten liquid. Therefore, application of laser to a powder mixture of the graphite powder and the silicon carbide powder under the condition of a temperature at which silicon carbide is decomposed into carbon and silicon, that is, at 2,800° C. or higher and lower than 3,500° C., enables the graphite powder to be solidified where the molten liquid of silicon serves as a binder. Silicon carbide is not decomposed at lower than 2,800° C. so that a molten liquid of silicon is not generated, and silicon carbide sublimates at 3,500° C. or higher so that modeling is difficult.

Although the decomposition temperature and the sublimation temperature of the silicon carbide are some what changed in accordance with purity of the silicon carbide powder and the type of an impurity, increasing the temperature of silicon carbide to a temperature range of 2,800° C. or higher and lower than 3,500° C. enables silicon carbide to be thermally decomposed so as to generate a molten liquid of silicon. The molten liquid of silicon permeates between the graphite powder and is solidified after the laser light passed. As a result, the graphite powder is solidified so that modeling can be performed.

The binder being silicon enables the precision during modeling to be maintained since degreasing is not necessary thereafter in contrast to an organic binder. Increasing the temperature of silicon carbide to a temperature range of 2,800° C. or higher and lower than 3,500° C. enables silicon carbide to be decomposed so as to generate a molten liquid of silicon, and it is more favorable that the temperature is increased to 2,900° C. or higher and 3,400° C. or lower. In this temperature range, the molten liquid of silicon can be stably generated.

The raw material powder used for the present invention is a powder mixture of the graphite powder and the silicon carbide powder. To obtain physical properties close to those of an article composed of simple graphite (graphite article), a total of the graphite powder and the silicon carbide powder is 90% by mole or more of the total powder, preferably 95% by mole or more, and more preferably 98% by mole or more in accordance with the application.

Further, the proportion of the graphite powder being increased enables the physical properties of the resulting modeled object to become closer to those of graphite. However, when the proportion of the silicon carbide powder serving as the binder is excessively decreased, modeling becomes difficult. Therefore, the raw material powder has to contain 20% by mole or more of the silicon carbide powder. In this regard, in consideration of use for the application akin to that of the graphite article, the content of the silicon carbide powder in the raw material powder is preferably 50% by mole or less. Therefore, the content of the silicon carbide powder in the raw material powder is preferably 20% by mole or more and 50% by mole or less and more preferably 25% by mole or more and 40% by mole or less.

When the raw material powder contains a resin having a low melting point, there is a concern that a powder around the resin may be scattered due to bumping or vaporization caused by laser light irradiation. Therefore, the content of the resin in the powder is preferably less than 0.2% by mole, preferably 0.1% by mole or less, and further preferably 0.05% by mole or less.

The particle diameter of a particle contained in the raw material powder is preferably 0.5 μm or more and 200 μm or less and more preferably 1 μm or more and 70 μm or less. The particle contained in the raw material powder being in this range enables the particle fluidity suitable for laying of the powder during modeling to be obtained and enables a fine shape to be modeled.

In the powder bed fusion, in general, the temperature of a laser light irradiation portion is adjusted by the irradiation intensity (laser power) of the laser light, the scanning rate of the laser light, the scanning interval of the laser light, and the thickness of the powder. In addition to this, performing laser light dispersive irradiation, decreasing a temperature gradient in a laser light irradiation spot, and controlling an auxiliary heating temperature of the powder and the modeled object enable the temperature of the silicon carbide in the laser light irradiation portion to be increased to a more appropriate temperature range. As a result, it is possible to stably thermally decompose the silicon carbide so as to generate a molten liquid of silicon.

A rough configuration of a modeling apparatus and a modeling process will be described below, and thereafter a method for manufacturing an article containing graphite by using a graphite powder will be described.

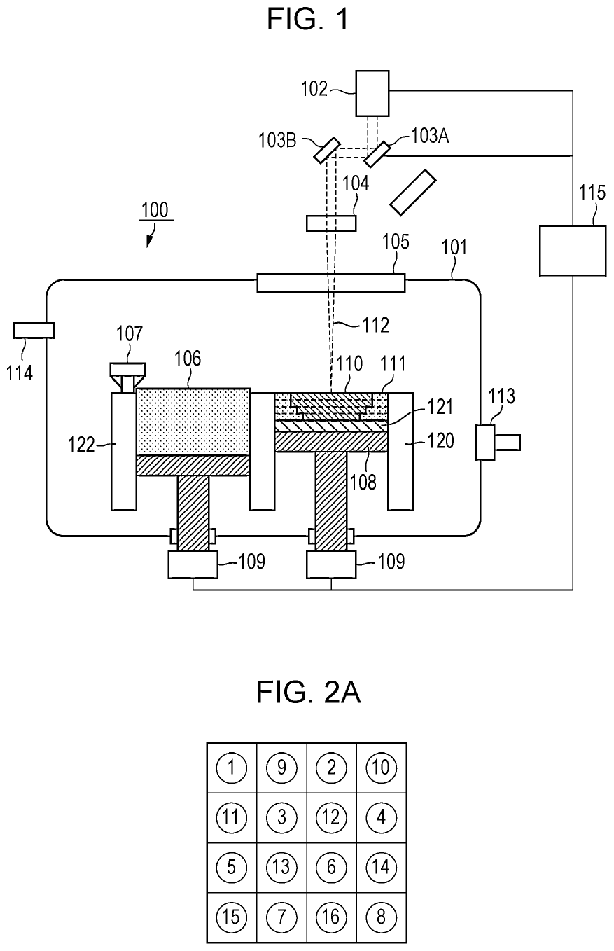

The configuration of a modeling apparatus 100 used for the powder bed fusion is schematically illustrated in FIG. 1. The modeling apparatus 100 includes a chamber 101 provided with a gas inlet 113 and an exhaust gas outlet 114, a gas is introduced from the gas inlet 113, and an exhaust gas is discharged from the exhaust gas outlet 114 so that the internal atmosphere can be controlled. To control the pressure, a pressure control mechanism such as a butterfly valve may be connected to the exhaust gas outlet 114, or a configuration capable of adjusting the atmosphere in the chamber in accordance with supply of gas and the resulting pressure increase (generally called blow substitution) may be connected. In this regard, FIG. 1 illustrates an example of the modeling apparatus, and the modeling apparatus is not limited to this and may be appropriately modified.

In the interior of the chamber 101, a modeling container 120 to model a three-dimensional object and a powder container 122 to store a raw material powder (hereafter also referred to simply as powder) 106 are included. The modeling container 120 has a heating function so as to be capable of heating the powder and the modeled object in the container.

The position of the bottom portion of each of the modeling container 120 and the powder container 122 can be changed in the vertical direction by a lifting mechanism 109. The bottom portion of the modeling container 120 also functions as a modeling stage 108 on which a base plate 121 can be placed.

The raw material powder stored in the powder container 122 is transported to the modeling container 120 by a powder-laying mechanism 107 and is laid having a predetermined thickness on the base plate 121 disposed on the modeling stage 108. The movement direction and the amount of movement of the lifting mechanism 109 is controlled by a control portion 115 in accordance with the thickness of the raw material powder laid on the base plate 121. In general, the raw material powder having a thickness of 10 μm or more and 50 μm or less is laid on the base plate 121, and, therefore, it is desirable that the height resolution ability of the lifting mechanism 109 be 1 μm or less.

The powder-laying mechanism 107 includes at least one of a squeegee and a roller to transport the raw material powder 106 from the powder container 122 to the modeling container 120 and to lay and level the raw material powder 106 having a predetermined thickness. To increase the density of the modeled object, a configuration in which both the squeegee and the roller are included so as to adjust the thickness of the powder by the squeegee and to increase the density of the powder by performing pressurization with the roller is favorable.

The modeling apparatus 100 further includes a laser light source 102 to melt the laid raw material powder, a scanning mirrors 103A and 103B to make the laser light 112 biaxially scan, and an optical system 104 to condense the laser light 112 on the irradiation portion. Since the laser light 112 is applied from outside the chamber 101, the chamber 101 is provided with an inlet window 105 to introduce the laser light 112 into the interior. Various parameters related to the laser light 112 are controlled by the control portion 115. Favorably, the positions of the modeling container 120 and the optical system 104 are adjusted in advance such that the beam diameter of the laser light is set to be a predetermined value on the surface of the laid raw material powder 106. The beam diameter on the surface of the laid raw material powder 106 has an influence on the modeling precision and is preferably set to be 30 μm or more and 100 μm or less and more preferably set to be 30 μm or more and 50 μm or less.

A galvanometer mirror is suitable for use as the scanning mirrors 103A and 103B. The galvanometer mirror is operated at high speed while reflecting the laser light and, therefore, is desirably made of a lightweight material having a low linear expansion coefficient.

A highly versatile YAG laser is frequently used as the laser light source 102, but a CO₂ laser, a semiconductor laser, or the like may also be used. The driving system may be a pulse system or a continuous irradiation system. The light with a wavelength in accordance with the absorption wavelength of the raw material powder 106 may be selected as the laser light 112. It is preferable that the light with a wavelength at which the raw material powder 106 has absorptance of 50% or more be used, and it is more preferable that the light with a wavelength at which the raw material powder 106 has absorptance of 80% or more be used.

Next, the modeling process will be described.

Initially, the base plate 121 is placed on the modeling stage 108, and the interior of the chamber 101 is substituted with an inert gas such as nitrogen or argon. After substitution is completed, the raw material powder 106 is laid on the modeling surface of the base plate 121 by using the powder-laying mechanism 107. The thickness of the raw material powder 106 to be laid is determined in accordance with a slice pitch, that is, a stacking pitch, of the slice data formed from shape data of the three-dimensional model to be modeled.

The raw material powder 106 is scanned by the laser light 112 in accordance with the slice data, and the raw material powder in a predetermined region is irradiated with the laser light. Regarding the region irradiated with the laser light 112, the raw material powder 106 is solidified and becomes a solidified portion 110, and regarding the region not irradiated with the laser light 112, the powder itself becomes an unsolidified portion 111.

After laser light irradiation based on the slice data of one layer is completed, the modeling stage 108 is lowered and the bottom portion of the powder container 122 is lifted by using the lifting mechanism 109 in accordance with the stacking pitch. Subsequently, the raw material powder 106 in the powder container 122 is transported to the modeling container 120 by using the powder-laying mechanism 107, the new raw material powder is laid on the modeling surface composed of the solidified portion 110 (modeled object) and the unsolidified portion 111, and the laser light 112 is applied while scanning. Hereafter the solidified portion 110 corresponding to the slice data of one layer is referred to as a solidified layer, and a portion composed of stacked and integrated solidified layers is referred to as a solidified portion 110.

The base plate 121 formed of a meltable material such as stainless steel is used. When the raw material powder laid on the base plate 121 at first is melted and solidified, the raw material powder and a portion of the base plate surface are melted, the first solidified layer and the base plate 121 are integrated, and the modeled object can be fixed to the base plate 121 without shifting of the position during modeling.

When the raw material powder laid on the solidified portion 110 is irradiated with the laser light, it is favorable that scanning be performed under the condition that the raw material powder and the surface of the solidified portion 110 are remelted and solidified. In a boundary between a newly formed solidified layer and the solidified portion 110, the materials are mixed with each other and solidified so as to be integrated. Consequently, the solidified portion 110 can be fixed to the base plate 121 without shifting of the position during modeling. After modeling is completed, the base plate 121 is mechanically separated from the modeled object.

Accordingly, the step of laying the raw material powder on the modeling surface and the step of applying the laser light 112 while scanning being performed a plurality of times enables a three-dimensional object that is integrated solidified layers (modeled object, solidified portion) to be produced.

As described above, since silicon carbide is a sublimable substance, when a portion the temperature of which is increased to 3,500° C. or higher is included in a region irradiated with the laser light, rapid vaporization scatters the powder around the silicon carbide, and modeling becomes difficult. Therefore, in the present invention, as described above, performing laser light dispersive irradiation, decreasing a temperature gradient in an irradiation spot, and controlling an auxiliary heating temperature in addition to controlling the laser power, the laser light scanning rate, the laser light scanning interval, and the powder thickness enable more stable modeling to be performed.

The methods for controlling the laser power include a method in which an in-plane power density is controlled and a method in which a space power density is controlled. The in-plane power density is laser light irradiation intensity per unit area, and the unit is expressed as J/mm². The space power density is laser light irradiation intensity per unit volume, and the unit is expressed as J/mm³. When a modeled object is formed by controlling the raw material powder thickness as in the powder bed fusion, it is appropriate to consider the space power density. The space power density Jᵥ is denoted by the following formula.

$${J}_{v} = W / ( P \times V \times D )$$

Herein, W represents a laser power, P represents a laser light irradiation pitch (scanning interval), V represents a laser light scanning rate, and D represents a raw material powder thickness. In common modeling, the laser power W is 10 W or more and 1,000 W or less, the laser light irradiation pitch P is 5 μm or more and 500 μm or less, the laser light scanning rate is 10 mm/sec or more and 10,000 mm/sec or less, and the raw material powder thickness D is 5 μm or more and 500 μm or less. It is sufficient that the parameters of W, P, V, D are controlled where the above-described ranges are rough targets so as to control Jᵥ to be 10 J/mm³ or more and 100 J/mm³ or less. The lower limit of 10 J/mm³ is energy necessary for melting the power to such an extent that the silicon carbide powder can be solidified. The upper limit of 100 J/mm³ is a region in which silicon carbide is vaporized and modeling becomes impossible.

In addition to controlling the laser light space power density Jᵥ, performing adjustment of a laser light irradiation method, a focus position, and the like decreases temperature variations due to laser light irradiation and enables modeling to be stably performed while silicon carbide is decomposed so as to generate a molten liquid of silicon.

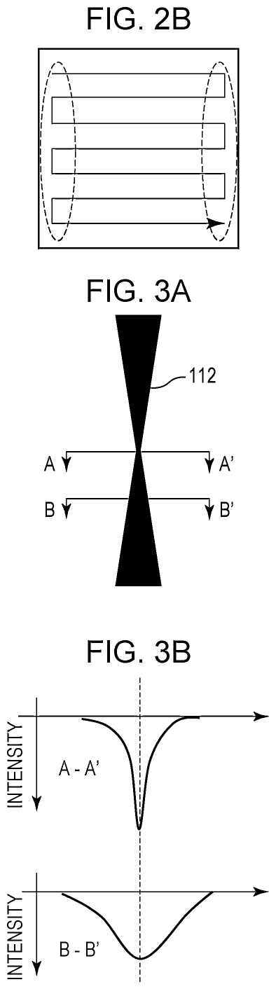

As illustrated in FIG. 2B, when the laser light continuously scans in a unicursal manner in accordance with the shape of the laser light irradiation region, irradiation heat is accumulated in a portion in which a plurality of scanning turn places are near each other (a region surrounded by a broken line in the drawing), and the temperature is locally increased. As a result, scattering of the raw material powder occurs due to vaporization of silicon carbide in a portion in which a plurality of scanning turn places are near each other, variations occur in the composition of the modeled object, or voids are generated.

However, performing laser light dispersive irradiation enables the number of times of scanning turns near each other to be decreased so as to suppress local temperature increase and to decrease temperature variations in the modeling surface. Specifically, as illustrated in FIG. 2A, it is favorable that the irradiation region be divided into a plurality of regions, and irradiation be discretely performed. An example of the irradiation order is described in each region. The size of the irradiation region is favorably a rectangle with a side of 1 mm or more and 5 mm or less and an area of 1 mm² or more and 25 mm² or less. However, the shape of the irradiation region is not limited to being a rectangle and may be a polygon or circle or a combination thereof provided that the area is 1 mm² or more and 25 mm² or less, but it is favorable that a plane be filled with a combination of a small number of shapes of one type or few types. The size of a region divided into a rectangle is preferably 5 mm×5 mm or less and more preferably 2 mm×2 mm or less.

In this regard, it is also favorable to decrease a temperature gradient in a laser light irradiation spot. Specifically, it is favorable that the laser light in a defocus state be applied to the powder. The focus state and the defocus state will be described with reference to conceptual diagrams of FIG. 3A and FIG. 3B. The focus state denotes a state in which the laser light is focused on the surface of the laid powder, and the defocus state denotes a state in which the laser light is not focused on the surface of the laid powder. Specifically, the defocus state is a state in which a focus position specified from the light condensing optical system of an apparatus in use is shifted from the surface of the laid powder.

The light intensity distribution at the focus position of the laser light 112 (a section taken along line A-A′ in FIG. 3A) is a sharp Gaussian distribution as illustrated in upper diagram of FIG. 3B. On the other hand, the intensity distribution at the defocus position of the laser light 112 (in the vicinity of a section taken along line B-B′ in FIG. 3A) is a gentle intensity distribution, as illustrated in lower diagram of FIG. 3B, compared with that at the focus position.

In particular, at the focus position, since a difference in the light intensity between the central portion of the irradiation spot and the peripheral portion increases, when the laser light in the focus state is applied to the raw material powder, a large temperature gradient is generated in the irradiation spot, and it is concerned that heating at higher than 3,500° C. may be partly performed. However, applying the laser light in the defocus state to the modeling powder enables the temperature gradient in the irradiation spot to be decreased.

Regarding the method for decreasing the temperature gradient in the irradiation spot, the method in which defocusing is performed has been described, but the method is not limited to this. For example, a method in which a modeling powder is irradiated where the light intensity exhibits a top hat type distribution by using a beam shaping element is also favorable.

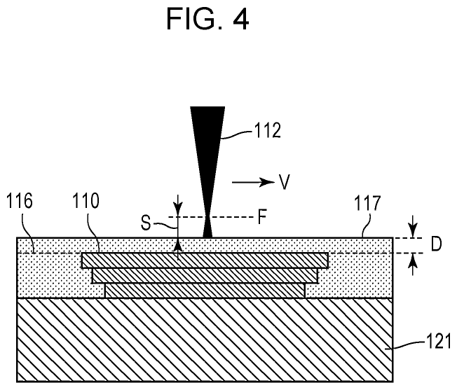

FIG. 4 illustrates a manner in which modeling is performed by applying laser light 112 in a defocus state to a raw material powder 117 laid on a modeling surface 116. The raw material powder 117 is a powder laid to form a layer of solidified layer. In FIG. 4, the focus position F is shifted to above (in the direction away from the base plate 121) the surface of the raw material powder 117 laid on the modeling surface 116.

Regarding the method for defocusing, two patterns are considered, that is, a method in which the focus position F of the laser light 112 is shifted to above the surface of the raw material powder 117 laid on the modeling surface 116 and a method in which the focus position F is shifted to below. However, when the focus position F is shifted to below the surface of the raw material powder 117, there is a concern that a solidified portion or a raw material powder below the modeling surface 116 may be bumped or sublimated so as to generate voids in the solidified portion or that a non-modeled portion may be solidified so as to form a solidified portion not based on the slice data.

Therefore, when the laser light 112 in the defocus state is applied to the raw material powder 117, the optical system is adjusted such that the focus position F of the laser light 112 is shifted to above the surface of the raw material powder 117 laid on the modeling surface, as illustrated in FIG. 4. When the distance (amount of defocus) S between the focus position F and the surface of the raw material powder 117 is excessively small, the temperature gradient in the irradiation region is not decreased, and a molten material of the powder tends to cause bumping. In addition, when the amount of defocus S is excessively large, the powder is not melted, and modeling is impossible. Therefore, the amount of defocus S has to be set within an appropriate range. When a YAG laser is used, the amount of defocus S is set to be preferably more than 0 mm and 15 mm or less and more preferably 5 mm or more and 10 mm or less in accordance with the optical system of the used modeling apparatus.

To form a solidified portion 110 (modeled object) by stacking a plurality of solidified layers, adhesiveness between a solidified layer formed before and a solidified layer formed next has to be increased. To increase adhesiveness, it is favorable that silicon melted due to thermal decomposition be made to permeate up to the interface to the solidified layer formed before, and this can be realized by adjusting the thickness of the laid powder. According to an experiment, the thickness of the raw material powder laid at a time, where modeling can be performed while the adhesiveness between the solidified layers is sufficiently maintained, is preferably 5 μm or more and 200 μm or less although the thickness may depend on the modeling conditions. In consideration of the time required for modeling and the modeling precision, 10 μm or more and 100 μm or less is more preferable.

Regarding the base plate 121, metal materials such as aluminum and stainless steel having a relatively low melting point are frequently used. This is because, when the first solidified layer is modeled, a portion of the base plate 121 being melted integrates the solidified layer and the base plate 121 so as to fix the solidified portion 110 to the base plate 121. Since the metal materials have high thermal conductivity, when the temperature is increased by laser light irradiation, the heat tends to diffuse into the surroundings, the heat of the powder is dissipated to the base plate 121 so that melting becomes insufficient, and fixing of the solidified portion 110 to the base plate 121 may become difficult. When modeling proceeds and the height of the solidified portion 110 is increased, diffusion of the heat into the base plate is decreased. However, since the modeled object takes on a state of being imbedded in a powder bed having high thermal conductivity, the heat is dissipated through the surrounding powder, and an increase in the temperature of the powder by application of the laser light tends to become insufficient.

To improve such a state, it is favorable that a modeling container 120 be provided with a heating mechanism, and the base plate 121, the solidified portion (modeled object) 110, and the powder of the unsolidified portion 111 be preheated. The heating mechanism is favorably capable of heating the solidified portion (modeled object) 110 and the powder of the unsolidified portion 111 to 30° C. or higher and 100° C. or lower. For example, a heater may be disposed around the modeling container 120, or a laser to perform preheat may be disposed separately from the laser to melt the powder. When the preheat temperature is lower than 30° C., the heat is diffused so that the raw material powder is unable to be sufficiently melted during laser light irradiation, voids may be generated between the base plate 121 and the solidified portion 110 and between the solidified portion 110 and the solidified layer to be stacked, and pealing may occur. When the preheat temperature is higher than 100° C., the raw material powder tends to be agglomerated.

The thus obtained modeled object contains, in addition to graphite, silicon and carbon generated by thermal decomposition without being further treated. However, the modeled object being subjected to heat treatment enables the physical properties of the modeled object to be improved since silicon and carbon contained in the modeled object react with each other so as to form silicon carbide. The melting point of silicon is 1,414° C., and it is known that silicon and carbon are converted to silicon carbide by being brought close to each other and subjected to heat treatment at 1,300° C. so as to cause a reaction. Since silicon carbide is thermally decomposed at 2,800° C. or higher, the heat treatment temperature after modeling is set to be preferably 1,300° C. or higher and 2,800° C. or lower and more preferably 1,500° C. or higher and 2,500° C. or lower.

The modeled object produced by the above-described method has a specific structure. When the modeled object after modeling or after modeling and heat treatment is evaluated by Raman spectroscopy in the depth direction from the surface of the last modeling side, in a region having a thickness corresponding to one solidified layer, detected silicon carbide increases with increasing proximity to the base plate 121. In addition, in an observed structure, a region in which the ratio of silicon carbide to graphite changes in one direction periodically appears in accordance with the thickness of the laid powder (the thickness of the solidified layer) and the number of stacked layers. Consequently, it is conjectured that, when the powder mixture is irradiated with the laser under an appropriate condition, silicon carbide on the surface layer side is thermally decomposed into silicon and carbon, melted silicon permeates the powder laid by gravity, and reacts with graphite so as to be converted to silicon carbide and be solidified bonding the surrounding powder.

The modeled object produced by the above-described procedure includes voids in the interior in accordance with the packing density of the laid powder. The filling factor of the power is about 70% even when closest packing is performed, and the powder cannot be prevented from scattering during modeling. Consequently, the porosity of the powder is about 40% to 50%. Therefore, it is also favorable that the modeled object be subjected to impregnation so as to improve the density, that is, the mechanical strength. Since performing pitch impregnation enables voids to be changed to graphite, the physical properties of the finally obtained article can be brought closer to those of graphite.

Regarding pitch impregnation, initially, the modeled object is immersed in a pitch, and pressure is applied so as to impregnate the interior of the modeled object with the pitch. When pitch impregnation is performed, deaerating the modeled object in a vacuum and heating the modeled object to a temperature higher than or equal to the softening point of the pitch enables pitch impregnation to be readily performed. The modeled object impregnated with the pitch is fired at 700° C. to 1,000° C. so as to convert the pitch to a carbonaceous material, and thereafter pitch impregnation and firing are repeated a plurality of times as the situation demands. After voids included in the modeled object are decreased by the carbonaceous material in accordance with the characteristics required of the article, and heating is performed at 2,700° C. to 3,000° C. so as to convert the carbonaceous material to graphite. The carbonaceous material being graphitized grows a crystal structure and enables physical property values intrinsic to graphite to be obtained. Consequently, the resulting article exhibits physical properties closer to those of graphite since the proportion of graphite increases.

### EXAMPLES

Examples according to the present invention will be described. However, the type, the composition, the particle diameter, and the shape of the powder, the power of the laser, and the like described below should be appropriately changed in accordance with the configuration of an apparatus to which the present invention is applied and various conditions and are not intended to limit the present invention to within the range disclosed in the present specification.

### Example 1

Regarding a raw material powder, a graphite powder having an average particle diameter of 30 μm (trade name SG-BL 30, produced by Ito Graphite Co., Ltd., graphite of 99.0 at %) and a silicon carbide powder having an average particle diameter of 14.7 μm (trade name NC #800, produced by Pacific Rundum Co., Ltd., silicon carbide of 98.7 at %) were used. A stainless steel base plate 121 was disposed on a stage 108.

A graphite powder and a silicon carbide powder were mixed at a ratio of 50% by mole:50% by mole and, thereafter, left to stand in a chamber, and a step of performing evacuation and introduction of a N₂ gas was performed a plurality of times so as to substitute the interior of the chamber with an inert atmosphere. An argon gas rather than the N₂ gas may be used. A heater of a modeling container 120 was set at 40° C., and the powder mixture and the base plate 121 were preheated. The height of a stage 108 was adjusted, and the powder mixture in a powder container 122 was supplied onto the stage 108 by a powder-laying mechanism 107 and was laid on the base plate 121 so as to have a thickness of 50 μm.

Subsequently, the powder was irradiated with laser light so as to be modeled. The amount of defocus S of the laser light 112 was adjusted by lifting or lowering the stage and was set to be 7 mm. A Nd:YAG laser with a wavelength of 1,060 nm was used as a laser light source. A laser power was set to be 100 W, a pitch was set to be 40 μm, and a scanning rate was set to be 2,000 mm/sec. The laser space power density in such an instance was calculated resulting in 25 J/mm³. After laser light irradiation of the first layer was completed, the step of laying the powder and the step of applying the laser light in the same manner was repeated a plurality of times until the modeled object had a predetermined height.

Stainless steel used for the base plate 121 has relatively high thermal conductivity, the irradiation heat of the applied laser light is dissipated, and the adhesiveness between the modeled object and the base plate may deteriorate. In such an instance, in addition to the preheat, the laser space power density during modeling of the first layer to the third layer may be increased to 50 J/mm³.

Laser light dispersive irradiation was performed. Specifically, an irradiation zone was set to be a square with each side of 1 mm, a center-to-center distance between adjacent squares was set to be 0.8 mm, and adjacent irradiation zones were overlapped by 0.1 mm. Of two successively formed solidified layers, regarding the secondly formed solidified layer, the irradiation zones were parallel translated by 0.25 mm in a certain direction in the modeling surface and the angle in the modeling plane was 18° rotated relative to the firstly formed solidified layer. These devices enabled the temperature uniformity in the modeling surface to be ensured and enabled the modeled object having relatively high strength to be obtained.

When neither parallel translation nor rotation was performed in the modeling surface, the modeled object was formed by the square solidified layers with each side of 1 mm being stacked and took on a state in which quadrangular prisms adhered side by side. Regarding such a modeled object, the bonding force between the quadrangular prisms is weak, and the modeled object tended to be damaged.

After modeling by laser irradiation was completed, a step of immersing the modeled object in a pitch, applying pressure to perform impregnation, and firing the pitch-impregnated modeled object at 1,000° C. was repeated a few times so as to decrease the porosity. Subsequently, the temperature of the modeled object was increased to 3,000° C. by electrical heating so as to convert the carbonaceous material of the pitch to graphite. Although the porosity of the resulting modeled object before pitch impregnation was about 50%, void portions were filled due to pitch impregnation, and the final composition was about 75% by mole of graphite and 25% by mole of silicon carbide.

As a result of texture observation by using a microscope, almost no voids were observed in the resulting article.

In addition, the bending strength and the resistivity of the resulting article were evaluated. Each of the physical properties was evaluated by the following method.

### Bending Strength

The bending strength was evaluated by a three-point bending test. Five specimens were produced by the above-described method. Regarding each specimen,

$$3 \times P \times L / ( 2 \times w \times t ) \qquad ( Formula 1 )$$

was calculated where a maximum breaking load is denoted by P [N], a distance between external fulcrums is denoted by L [mm], a width of the specimen is denoted by w [mm], and a thickness of the specimen is denoted by t [mm], and an average value of these was taken as a bending strength.

### Electric Resistivity

The electric resistivity was measured by using a four-terminal method while supply of a constant current from a current source to the specimen produced by the above-described method was maintained.

As a result of the evaluation, the bending strength of the resulting article was 54.3 MPa, the electric resistivity was 13.3 μΩ·m, and it was ascertained that the article had physical properties close to those of graphite in the related art.

### Example 2

In Example 2, a modeled object was produced in the manner akin to that in Example 1 except that, in graphite modeling, the composition of a silicon carbide powder serving as a binder was changed and modeling was performed.

Regarding the raw material powder, a graphite powder having an average particle diameter of 30.0 μm (trade name SG-BL 30, produced by Ito Graphite Co., Ltd., graphite of 99.0 at %) and a SiC powder having an average particle diameter of 14.7 pm (trade name NC #800, produced by Pacific Rundum Co., Ltd.) were used. The proportion of the graphite powder was set to be 80% by mole, the proportion of the silicon carbide was set to be 20% by mole, and mixing was performed by using a ball mill. Laser irradiation was performed under the condition akin to that in Example 1. As a result, a modeled object in which slight pattern deformation was observed at a corner portion was obtained.

From this result, it is considered that the content of the silicon carbide serving as the binder in the raw material powder was preferably 20% by mole or more. The composition after pitch impregnation was 90% by mole of graphite and 10% by mole of silicon carbide. The bending strength and the electric resistivity were evaluated in the manner akin to that in Example 1. As a result, the bending strength was 45.1 MPa, and the electric resistivity was 11.9 μΩ·m. Therefore, physical property values closer to the characteristics of graphite were obtained compared with Example 1.

### Comparative Example 1

Regarding Comparative example, modeling was performed by using a graphite powder alone.

Regarding the raw material powder, a graphite powder having an average particle diameter of 30.0 μm (trade name SG-BL 30, produced by Ito Graphite Co., Ltd., graphite of 99.0 at %) was used.

When modeling was performed by irradiating the raw material powder with the laser light under the condition akin to that in Example 1, the graphite powder was scattered in the irradiation portion, and a modeled object was unable to be stacked on the base plate. It is conjectured that the cause of this is due to graphite being unable to be melted and solidified by laser irradiation since a difference between the melting point and the boiling point was small.

According to the present invention, an article containing graphite can be produced with high precision at a low cost by the powder bed fusion.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A method for manufacturing an article containing graphite as a primary component, the method comprising:
laying a powder; and
solidifying the powder by applying laser light to the powder,
wherein the powder contains a graphite powder and a silicon carbide powder, and
in the solidifying of the powder, the laser light is applied under a condition that the silicon carbide powder is decomposed into carbon and silicon.

2. A method for manufacturing an article containing graphite as a primary component, the method comprising:
laying a powder; and
solidifying the powder by applying laser light to the powder,
wherein the powder contains a graphite powder and a silicon carbide powder,
a content of the silicon carbide powder in the powder is 50% by mole or less, and
in the solidifying of the powder, the laser light is applied under a condition that the silicon carbide powder is decomposed into carbon and silicon.

3. A method for manufacturing an article containing graphite, the method comprising:
laying a powder; and
solidifying the powder by applying laser light to the powder,
wherein the powder contains a graphite powder and a silicon carbide powder, and
in the solidifying of the powder, the laser light is applied under a condition that a temperature of a portion irradiated with the laser light reaches 2,800° C. or higher and lower than 3,500° C.

4. The method for manufacturing an article according to claim 1, wherein in the solidifying of the powder, a region in which the powder is solidified is divided into a plurality of parts, and the laser is discretely applied.

5. The method for manufacturing an article according to claim 4, wherein an area of the region is 1 mm² or more and 25 mm² or less.

6. The method for manufacturing an article according to claim 1, wherein a focus position of the laser light is located above a surface of the laid powder.

7. The method for manufacturing an article according to claim 6, wherein a distance between the focus position of the laser light and the surface of the laid powder is more than 0 mm and less than 10 mm.

8. The method for manufacturing an article according to claim 1, wherein the laser light is applied with a space power density set to be 10 J/mm³ or more and 100 J/mm³ or less.

9. The method for manufacturing an article according to claim 1, wherein a base plate on which the powder is laid and the powder are heated to a temperature of 30° C. or higher and 100° C. or lower during the laying of the powder and the solidifying of the powder.

10. The method for manufacturing an article according to claim 1, wherein a content of the silicon carbide powder in the powder is 20% by mole or more and less than 50% by mole.

11. The method for manufacturing an article according to claim 1, wherein an average particle diameter of the powder is 0.5 μm or more and 200 μm or less.

12. The method for manufacturing an article according to claim 1 further comprising:
impregnating a modeled object obtained by performing the laying of the powder and the solidifying of the powder with a pitch and performing firing so as to convert the pitch to a carbonaceous material; and
heating the carbonaceous material to cause graphitization.

13. An article comprising graphite and silicon carbide, wherein a region in which a composition of the silicon carbide changes in one direction is included, and the region periodically appears.

14. The article according to claim 13, wherein a period of the region is 5 μm or more and 500 μm or less.

15. A powder used for powder bed fusion,
wherein the powder contains a graphite powder and a silicon carbide powder, and
a total content of the graphite powder and the silicon carbide powder in the powder is 90% by mole or more of the powder and a content of the silicon carbide powder is 20% by mole or more and less than 50% by mole.

16. The powder according to claim 15, wherein the total content of the graphite powder and the silicon carbide powder in the powder is 95% by mole or more.

17. The powder according to claim 15, wherein the total content of the graphite powder and the silicon carbide powder in the powder is 98% by mole or more.

18. The powder according to claim 15, wherein the content of the silicon carbide powder in the powder is 25% by mole or more and 40% by mole or less.

19. The powder according to claim 15, wherein an average particle diameter is 0.5 μm or more and 200 μm or less.

20. The powder according to claim 15, wherein a content of a resin in the powder is less than 0.2% by mole.

21. The method for manufacturing an article according to claim 1, wherein in the solidifying of the powder, the laser light is applied under a condition that a temperature of a portion irradiated with the laser light reaches 2,800° C. or higher and lower than 3,500° C.

22. An article comprising graphite as a primary component,
wherein a plurality of graphite particles and silicon that functions as a binder between the plurality of graphite particles are included.

23. An article comprising graphite as a primary component,
wherein a plurality of graphite particles and silicon carbide that functions as a binder between the plurality of graphite particles are included.

24. The article according to claim 22,
wherein particle diameters of the plurality of graphite particles are 0.5 μm or more and 200 μm or less.

25. The article according to claim 13, wherein silicon carbide is 50% by mole or less.
